(19) United States
(12) Patent Application Publication
(10) Pub. No.: US 2024/0119020 A1
(43) Pub. Date: Apr. 11, 2024

(54) DRIVER TO PROVIDE CONFIGURABLE ACCESSES TO A DEVICE

(71) Applicant: Intel Corporation, Santa Clara, CA (US)

(72) Inventors: Kevin C. SCOTT, Forest Grove, OR (US); Miles PENNER, Newberg, OR (US)

(21) Appl. No.: 18/545,767

(22) Filed: Dec. 19, 2023

(51) Int. Cl. G06F 13/42

(52) U.S. Cl. CPC G06F 13/4221; G06F 2213/0026

(57) ABSTRACT

Examples described herein relate to utilizing a bus driver to present a peripheral device comprising a single physical function to a host operating system (OS) as a plurality of peripheral devices, associating the plurality of presented peripheral devices with a corresponding plurality of physical Ethernet ports; and enabling the host OS to interact with the plurality of peripheral devices. In some examples, the number of the plurality of peripheral devices correlates to the number of physical Ethernet ports associated with the peripheral device.

### BACKGROUND

In a server system, a processor-executed operating system (OS) provides a specific set of interfaces to a processor-executed device driver to control and monitor operations of a device. For example, a device such as a network interface controller (NIC) has provided a single host Peripheral Component Interconnect Express (PCIe) physical function (PF) interface for a physical Ethernet port to a network, of the NIC, to a Microsoft® Network Driver Interface Specification (NDIS) driver, for interface to a host-executed OS.

### BRIEF DESCRIPTION OF THE DRAWINGS

FIG. 1 depicts an example system.

FIG. 2A depicts an example of code segments.

FIG. 2B depicts an example of code segments.

FIG. 3A depicts an example process.

FIG. 3B depicts an example process.

FIG. 4 depicts an example process.

FIGS. 5A and 5B depict example network interface devices.

FIG. 6 depicts an example system.

### DETAILED DESCRIPTION

Kernel drivers conform to a specific set of interfaces provided by the host OS. When a new interface specification is created with added communications or commands, a specific configuration of NDIS may not provide a channel for the added communications or commands with the OS. For example, Intel® Infrastructure Processing Unit (IPU) provides a single host interface for multiple physical Ethernet ports exposed by the IPU to the host. However, expression of a single PF for multiple Ethernet ports may not be compatible with the NDIS driver as the NDIS driver controls a single port for a PCIe function.

According to some examples, a bus driver (e.g., Ethernet local area network (LAN) device bus driver) can access the IPU's physical function (PF) interfaces and provide access to multiple physical Ethernet ports to the OS as physical device objects (PDOs). More generally, the bus driver can provide access to one or more devices or circuitries by reads from one or more devices or circuitries or writes to the one or more devices or circuitries. Infrastructure Data Path Function driver (IDPF.sys or IDPF) can perform operations of an NDIS driver, as a Functional Device Object (FDO), and can attach to PDOs in order to communicate with the physical hardware (or PDO). The bus driver can also abstract the device initialization, resource allocation, and management of the physical device in a way that makes the IDPF driver change if the OS requires a new capability to be expressed. NDIS driver can communicate with an instance of the IDPF.sys driver. An instance of the IDPF driver can issue commands to the bus driver via virtual channel messages in order to abstract operations. The IDPF driver can access the physical device directly of directed assigned interfaces using SR-My or S-IOV technologies.

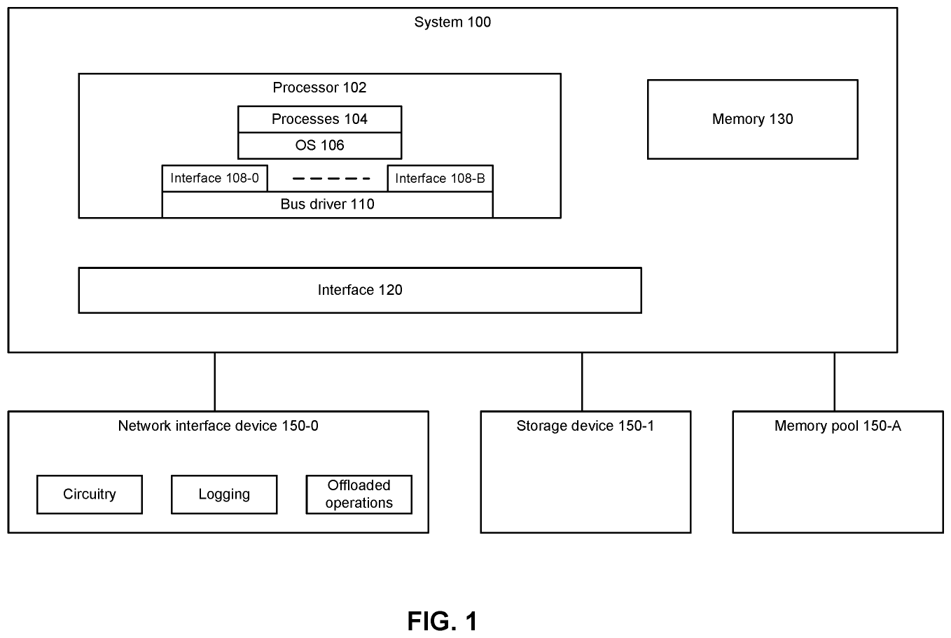

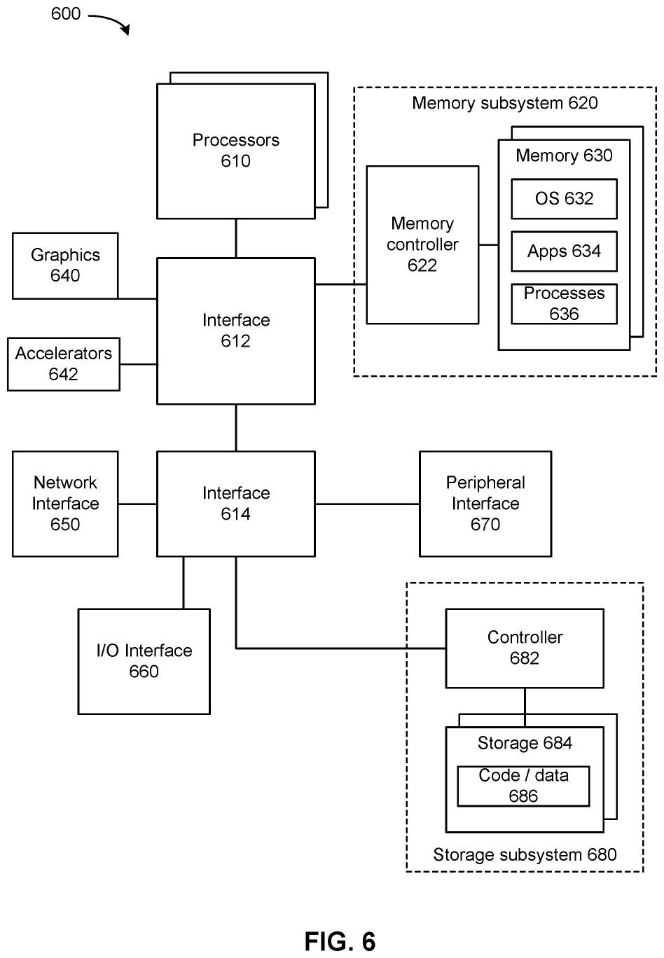

FIG. 1 depicts an example system. Server platform 100 can include processor 102, memory 130, interface 120, and one or more of devices 150-0 to 150-A, where A is an integer. Various examples of the server platform 100 can include circuitry and/or software described with respect to FIG. 6. Processor 102 can include one or more of: a CPU; a programmable packet processing pipeline; an accelerator; an application specific integrated circuit (ASIC); a field programmable gate array (FPGA); a graphics processing unit (GPU); a memory device; or other circuitry. Processor 102 can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

One or more of devices 150-0 to 150-A can include: one or more processors; one or more programmable packet processing pipelines; one or more accelerators; one or more hardware queue managers (HQM), one or more application specific integrated circuits (ASICs); one or more field programmable gate arrays (FPGAs); one or more graphics processing units (GPUs); one or more memory devices; one or more storage devices; one or more interconnects; one or more network interface devices; one or more servers; one or more computing platforms; a composite server formed from devices connected by a network, fabric, or interconnect; one or more storage devices; a memory pool (e.g., memory pool with physical memory); audio or sound processing device; or others. In some examples, a network interface device can refer to one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth).

For example, via interface 120, processor 102 and/or other circuitry can access one or more of devices 150-0 to 150-A via communications consistent with Peripheral Component Interconnect Express (PCIe), Compute Express Link (CXL), Universal Chiplet Interconnect Express (UCIe), Single Root I/O Virtualization (SR-IOV), or Scalable Input/Output (I/O) Virtualization (S-IOV) virtual device. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. Single Root I/O Virtualization (SR-MY) and Sharing specification, version 1.1, published Jan. 20, 2010 specifies hardware-assisted performance input/output (I/O) virtualization and sharing of devices. Intel® Scalable I/O Virtualization (S-IOV) permits configuration of a device to group its resources into multiple isolated Assignable Device Interfaces (ADIs). Direct Memory Access (DMA) transfers from/to an ADI are tagged with a unique Process Address Space identifier (PASID) number. Unlike the device partitioning approach of SR-IOV to create multiple virtual functions (VFs) on a physical function (PF), S-IOV enables software to flexibly compose virtual devices utilizing the hardware-assists for device sharing at finer granularity. An example technical specification for S-IOV is Intel® Scalable I/O Virtualization Technical Specification, revision 1.0, June 2018, as well as earlier versions, later versions, and variations thereof. For example, the IDPF driver can allocate resources in one or more of devices 150-0 to 150-A and bus driver 110 can provide one or more NDIS interfaces with resources to create an SR-IOV or S-IOV device. In other words, bus driver 110 can provide one of the NDIS interfaces with resources to create an SR-IOV or S-IOV device, but the IDPF driver allocate the SR-IOV or S-IOV device.

Processor 102 can execute at least operating system (OS), drivers, or processes. In some examples, drivers can include bus driver 110 for access to network interface device 150-0. In some examples, OS 106 can be Linux®, Windows® Server or personal computer, FreeBSD®, Android®, MacOS®, iOS®, VMware vSphere, openSUSE, RHEL, CentOS, Debian, Ubuntu, or any other operating system.

For example, OS 106 can separate memory or virtual memory into kernel space and user space to provide memory protection and hardware protection from malicious or errant software behavior. User space can be memory allocated to running applications and some drivers. Processes running under user space may have access to a limited part of memory, whereas the kernel may have access to all of the memory. Kernel space can be memory allocated to the kernel, kernel extensions, some device drivers and the operating system. A kernel can manage applications running in user space. Kernel space can be a location where the code of the kernel is stored and executes within.

Bus driver 110 can allow for addition or subtraction of interfaces 108-0 to 108-B, where B is an integer, to expose application programming interfaces (APIs) to allow processes 104 executed by processors 102 to communicate with devices 150-0 to 150-A. Developers can program interfaces 108-0 to 108-B for interaction with bus driver 110 and devices 150-0 to 150-A. Bus driver 110 can provide flexibility of presenting a number of different devices (e.g., devices 150-0 to 150-A) and associated interfaces to OS 106. For example, circuitry, firmware, and/or software in a network interface device 150-0 can be accessible to bus driver 110 and bus driver 110 in turn can provide communication with the circuitry, firmware, and/or software to the OS 106.

An Infrastructure Data Path Function (IDPF) driver can provide an Infrastructure Datapath Function driver for network interface devices and can act as a driver for PF/VF instances exposed to system 100 by a PCIe device (e.g., one or more of devices 150-0 to 150-A). Host PF/VF driver resources can be managed by the Control Plane running on bus driver 110. A control channel between bus driver 110 and processors of network interface device 150-A can use virtchnl 2.0 API for capability learning, negotiation, and resource configuration. For example, IDPF drivers can be executed in kernel space. In some examples, IDPF drivers may be utilized for capabilities that do not utilize a LAN or network interface device.

Bus driver 110 can conform to Microsoft® Kernel-Mode Driver Framework (KMDF) specification (e.g., Kernel-Mode Driver Framework version 1.11 update for Windows Vista, Windows Server 2008, Windows 7, and Windows Server 2008 R2, or earlier versions, later versions, or variations thereof), and command, configure, or read data or configurations from one or more of physical devices 150-0 to 150-A. As a KMDF driver, bus driver 110 can be executed by processor 102 and bus driver 110 can be enumerated by the PCIe subsystem as a PCIe device. For local area network (LAN) interfaces, bus driver 110 may allow an IDPF driver to directly control hardware, software, or data, such as transmit (Tx) and receive (Rx) queues of network interface device 150-0.

For example, bus driver 110 can export one or more Application Programming Interfaces (APIs) to allow an NDIS Child Device, and other capabilities bus driver 110 developer generates, to communicate with bus driver 110 and perform operations. As an example, in order to support an NDIS driver, the bus driver 110 can export an API which would allow the NDIS driver to discover Rx and Tx queues of multiple different virtual channels to control.

Bus driver 110 can provide OS 106 with capabilities to access offload circuitry, software, or data of one or more of devices 150-0 to 150-A. Bus driver 110 can perform operations of an Ethernet bus adapter, in some examples. Bus driver 110 can provide one or more of: decouple networking certifications from unclassified device certification activities; reduce code churn of drivers; allow the IDPF to provide access to virtual functions; access multiple physical versions of a network interface device; support new silicon (e.g., devices with new or different functionality); support operations of a network interface device independent of the OS support; or deploy offload operations before devices support the operations (e.g., hardware teaming, time-based packet transmission, new Request for Comments (RFCs) being considered by the Internet Engineering Task Force (IETF) or other organization, etc.)

One or more interfaces 108-0 to 108-B can plug into or communicate with bus driver 110, as opposed to one networking interface, to allow developers to extend or add new functionality to OS 106 and processes 104. One or more interfaces 108-0 to 108-B can communicate particular information or commands from process 104, OS 106, or driver 110 to a device or information or commands from a device to process 104, OS 106, or driver 110. For example, added capabilities provided to OS 106 and processes 104 can include at least: diagnose and debug deployment issues in device 150 based on access to device logs; expressing multiple virtual network interfaces to host OS, such as Virtual Functions, or non-direct assigned interfaces; expressing multiple networking services to the host/VM (e.g., Data Plane Development Kit (DPDK), local area network (LAN), storage, etc.) where the network interface device or bus driver can implement the multiple networking services and services can be available to the kernel and can be expressed over the virtual function and can be mapped directly to a process; provide extensible framework for enabling compatibility with future Ethernet controllers without changing a device driver as bus 110 driver abstracts away the differences in the silicon architecture and allows a common stable interface to OS 106; or embedding capabilities offloaded to network interface device 150-0 that would need to be used on less capable Ethernet devices such as: packet pacing, out of order completion queues, User Datagram Protocol (UDP) receive coalescing, quick UDP Internet Connections (QUIC) crypto offload, IPSec offload, or embedded teaming offload.

Processes 104 can be implemented as one or more of: microservices, virtual machine (VMs), microVMs, container, process, thread, or other virtualized execution environment. Processes 104 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some processes 104 can perform video processing or media transcoding (e.g., changing the encoding of audio, image or video files).

An example API called by bus driver 110 to OS 106 to identify capabilities is as follows:

```
typedef struct _BUS_INTERFACE_STANDARD {
  USHORT Size;
  USHORT Version;
  PVOID Context;
  PINTERFACE_REFERENCE InterfaceReference;
  PINTERFACE_DEREFERENCE InterfaceDereference;
  PTRANSLATE_BUS_ADDRESS TranslateBusAddress;
  PGET_DMA_ADAPTER GetDmaAdapter;
  PGET_SET_DEVICE_DATA SetBusData;
  PGET_SET_DEVICE_DATA GetBusData;
} BUS_INTERFACE_STANDARD,
*PBUS_INTERFACE_STANDARD;
```

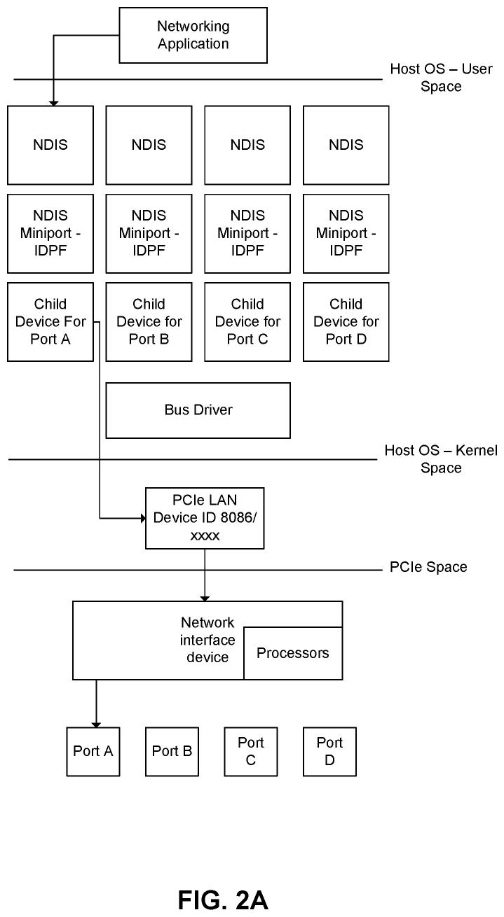

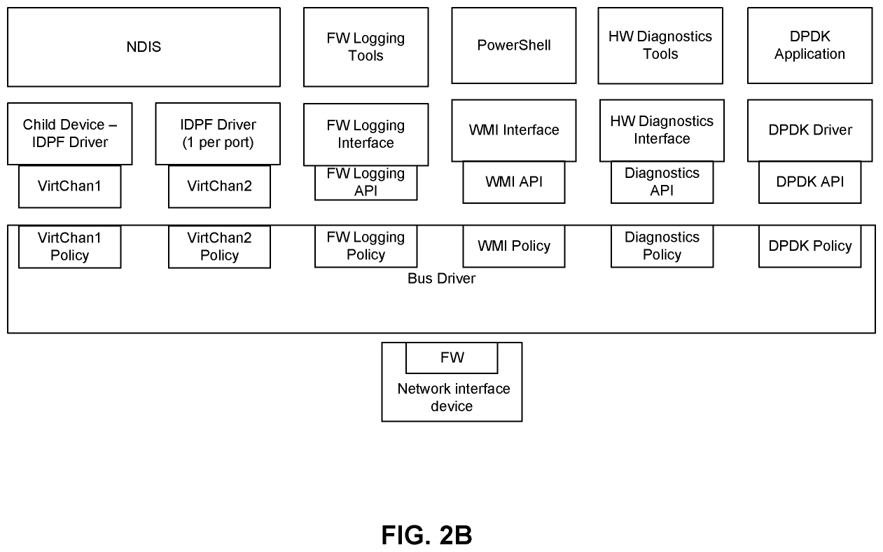

FIG. 2A depicts an example of code segments for providing access to multiple physical to a networking driver. Physical ports on the network interface device can be determined and a single child device can be allocated for a physical port. Capabilities of the network interface device can be allocated to one or more child devices. An instance of an IDPF driver can be loaded for a child device. For example, the bus driver can create OS resources to enable the loading of at least one IDPF driver. For example, one or more processor executed instances of an NDIS networking driver can communicate with IDPF driver per virtual channel or virtual function so that multiple physical ports of a single PCIe-accessible network interface device can be accessed as multiple virtual devices. For example, a user space application (e.g., networking application) could be used to obtain information from the network interface device or provide information or commands to the network interface device.

FIG. 2B depicts an example of software code segments. For example, interfaces can be provided for virtual channel policy, firmware (FW) logging policy, Windows Management Instrumentation (WMI) policy, diagnostics policy, DPDK policy, or others. A virtual channel policy can permit or limit the OS to write-to or read certain registers or data related to a virtual channel (e.g., packet context or queue information). A FW logic policy can allow or limit the OS to write-to or read certain registers or data related to firmware versions or update. A WMI policy can permit or limit the OS to write-to or read certain registers or data related to management of devices and applications in a network. A diagnostics policy can permit or limit the OS to write-to or read certain registers or data related to diagnostics information of a device. A DPDK policy can permit or limit the OS to access write-to or read registers with data or commands accessed by DPDK applications executing on the network interface device.

Applications can access the data from the device (e.g., network interface device) via the bus driver and interfaces. For example, NDIS can access virtual channels for configuring or monitoring packet transmission or receipt. For example, FW logging tools can access FW data to monitor firmware utilization or update firmware. For example, PowerShell can access certain registers or data related for management of devices and applications in a network to manage operations of the network interface device. For example, HW diagnostics tools can access diagnostics data to monitor operations of the network interface device. For example, a DPDK application can access data generated by one or more DPDK applications executing on the network interface device.

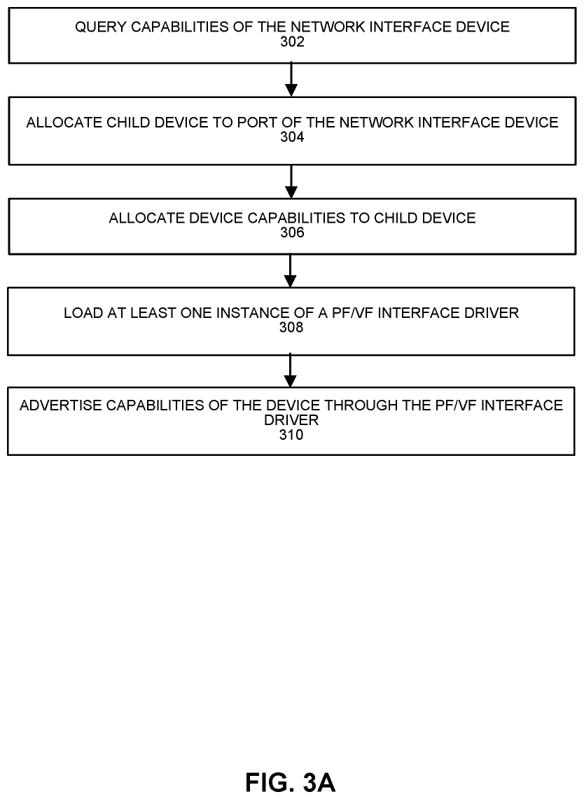

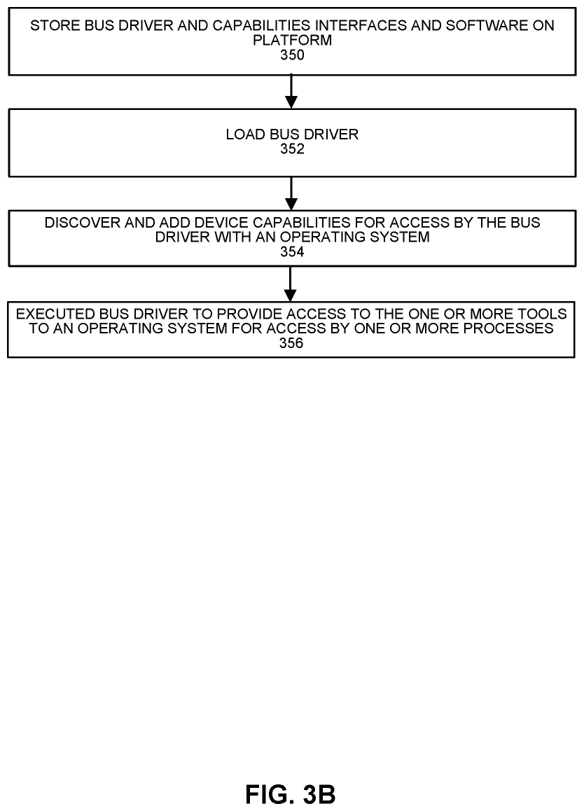

FIG. 3A depicts an example process to provide an OS with access to interfaces added to a bus driver. The process can be performed by one or more of: a bus driver, an administrator, a hypervisor, or an OS. One or more instances of an NDIS can communicate with IDPF driver per virtual channel or virtual function so that multiple physical ports of a single PCIe-accessible network interface device can be accessed as multiple virtual devices. At start-up of a device or OS, the bus driver can discover the number of ports, and construct a number of PDOs corresponding to the number of ports and offering LAN functionality. The OS can load the IDPF driver on the PDOs. For example, the process of FIG. 3A can generate code segments and perform operations described with respect to FIG. 2A. At 302, upon loading of the bus driver, the bus driver can query the capabilities of the device (e.g., network interface device) to discover the capabilities and features. At 304, a set of resources to associate with the child devices can be determined. In some examples, the number of physical ports on the network interface device can be determined and a single child device can be allocated for a physical port. A child device can represent a PDO and associated with a LAN device.

At 306, the discovered capabilities can be allocated to one or more child devices. Different LAN devices can provide different operations. For example, different virtual functions can utilize independent contexts for different ports. For example, a hypervisor can express multiple virtual ports, which express one or more queues, and can allocate the one or more queues among VFs or logical virtual ports (vports) for processes. In some examples, the discovered network interface device (e.g., LAN) capabilities can be allocated evenly or unevenly among available child devices.

At 308, at least one driver interface for PF/VF instances can be loaded. For example, an instance of IDPF driver can be loaded for a child device. For example, the bus driver can create OS resources to enable the loading of at least one IDPF driver. For example, OS resources can include one or more physical device objects (PDOs) or Functional Device Objects (FDOs). A PDO can represent a device on a bus to a bus driver. An FDO can represent a device to an IDPF driver.

At 310, the bus driver can advertise certain device capabilities to the OS. An IDPF driver can call the bus driver and indicate device capabilities for the bus driver to advertise to the OS. Accordingly, the IDPF may not communicate directly with the device, but can query the bus driver of capabilities the bus driver is to express to the OS. At this stage, the host OS can access added devices, which are visible to a user in an interface such as Windows Device Manager and to processes. The OS and user/administrator can interact with the capabilities as local area network (LAN) devices to enable or disable them or access data or provide commands. For example, a user space tool could be used to obtain information which is contained in a register and the bus driver can read registers and pass information from registers to the user space tool. A user space tool can be used to perform actions in the device.

FIG. 3B depicts an example process to add capabilities to a bus driver. The process can be performed by one or more of: a bus driver, an administrator, a hypervisor, or an OS. For example, the process of FIG. 3B can generate one or more capabilities interfaces and tools and can perform one or more operations and generate one or more code segments described with respect to FIG. 2B. At 350, a bus driver and one or more capabilities interfaces and tools can be stored in a platform. A table can be stored in memory that indicates APIs and software function pointer tables to the one or more capabilities interfaces and tools. The bus driver can be associated with a network interface device, in some examples. At 352, based on boot or re-boot of a system, the bus driver can be executed. At 354, the one or more capabilities interfaces and tools can be loaded for interaction with the bus driver. For example, the bus driver can advertise the one or more capabilities and if interfaces and tools for such capabilities are stored in memory, a plug and play manager can load such interfaces and tools for access by the bus driver. For example, a Microsoft® Plug and Play manager can match the one or more capabilities interfaces and tools with the bus driver so that interfaces and tools are accessible by the bus driver. At 356, the executed bus driver can provide access to one or more capabilities to an operating system for access by one or more processes. The one or more capabilities interfaces and tools and bus interface can execute in kernel space or user space.

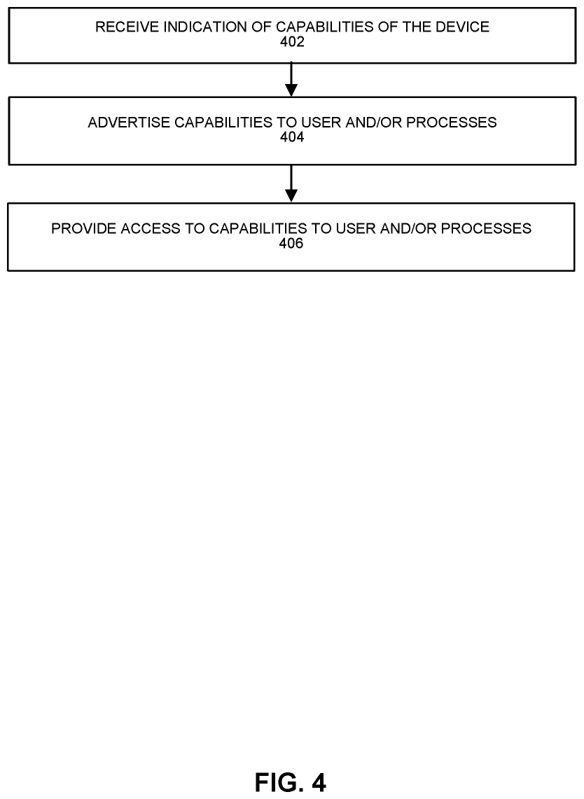

FIG. 4 depicts an example operation of an OS. At 402, the OS can receive indication of capabilities of a device advertised by individual drivers associated with the capabilities through a bus interface driver. For example, the individual drivers can be associated with the capabilities and can communicate capabilities to the bus driver and the bus driver can communicate the capabilities to the OS. In some examples, an individual driver includes an IDPF driver and the capabilities include virtual channel for LAN access (e.g., receipt and transmission) or other capabilities described herein. At 404, the OS can indicate device capabilities to a user or process for utilization. At 406, the OS can provide requested data to the user or process or provide data or commands from the user or process to the device. A register read or control queue calls into the device firmware can be used to access device status or data contained in the bus driver.

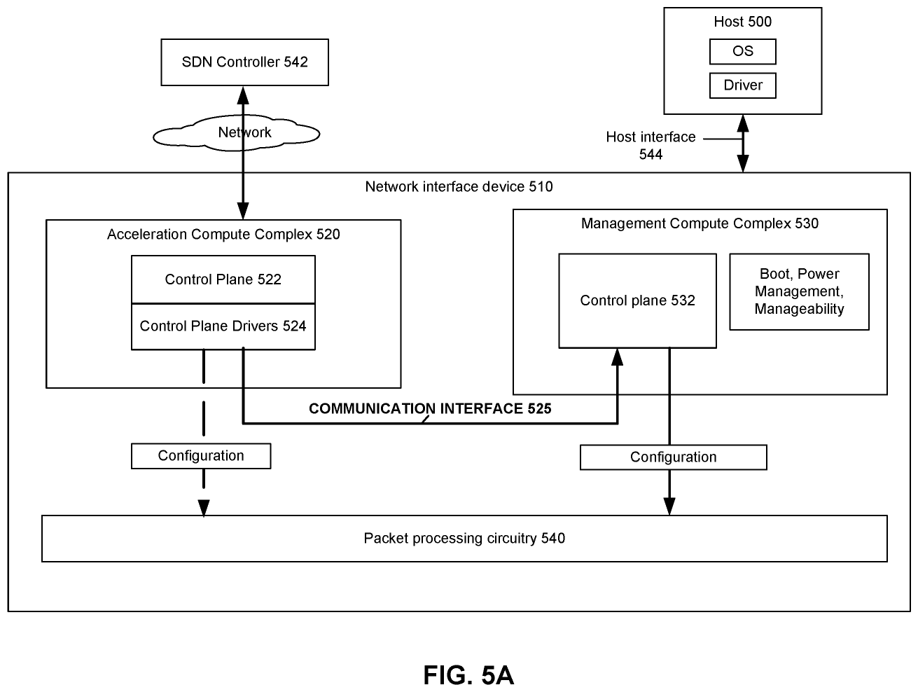

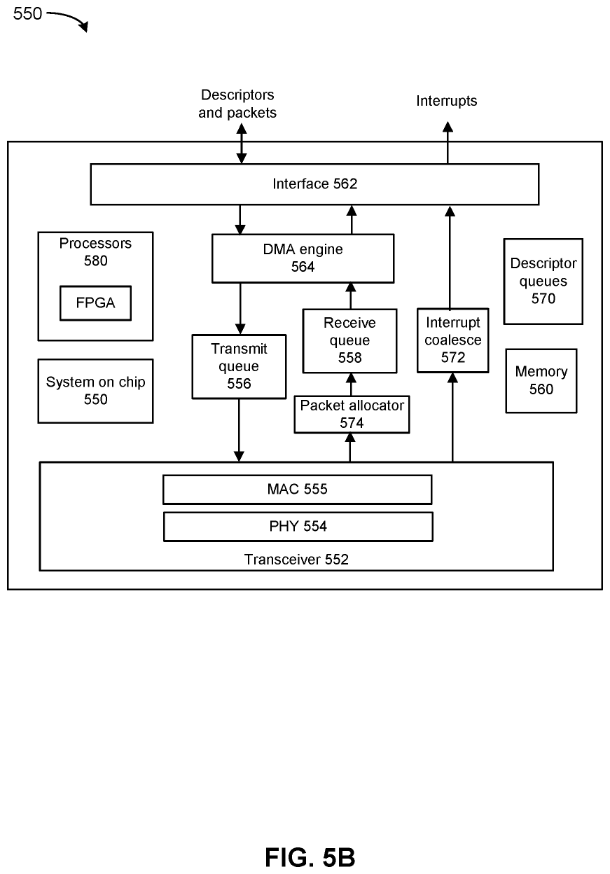

FIG. 5A depicts an example system. Host 500 can include processors, memory devices, device interfaces, as well as other circuitry such as described with respect to one or more of FIG. 5B, and/or 6. Processors of host 500 can execute software such as applications (e.g., microservices, virtual machine (VMs), microVMs, containers, processes, threads, or other virtualized execution environments), operating system (OS), and device drivers. An OS or device driver can configure network interface device or packet processing device 510 to utilize one or more control planes to communicate with software defined networking (SDN) controller 550 via a network to configure operation of the one or more control planes.

Packet processing device 510 can include multiple compute complexes, such as an Acceleration Compute Complex (ACC) 520 and Management Compute Complex (MCC) 530, as well as packet processing circuitry 540 and network interface technologies for communication with other devices via a network. ACC 520 can be implemented as one or more of: a microprocessor, processor, accelerator, field programmable gate array (FPGA), application specific integrated circuit (ASIC) or circuitry described at least with respect to FIG. 5B, and/or 6. Similarly, MCC 530 can be implemented as one or more of: a microprocessor, processor, accelerator, field programmable gate array (FPGA), application specific integrated circuit (ASIC) or circuitry described at least with respect to FIG. 5B, and/or 6. In some examples, ACC 520 and MCC 530 can be implemented as separate cores in a CPU, different cores in different CPUs, different processors in a same integrated circuit, different processors in different integrated circuit.

Packet processing device 510 can be implemented as one or more of: a microprocessor, processor, accelerator, field programmable gate array (FPGA), application specific integrated circuit (ASIC) or circuitry described at least with respect to FIG. 5B, and/or 6. Packet processing pipeline circuitry 540 can process packets as directed or configured by one or more control planes executed by multiple compute complexes. In some examples, ACC 520 and MCC 530 can execute respective control planes 522 and 532.

As described herein, data and registers in network interface device 510 and packet processing device 510, ACC 520, and/or MCC 530 can be configured or accessed by communications received from a bus driver via one or more child device drivers (e.g., IDPF drivers) or other interfaces.

SDN controller 542 can upgrade or reconfigure software executing on ACC 520 (e.g., control plane 522 and/or control plane 532) through contents of packets received through packet processing device 510. In some examples, ACC 520 can execute control plane operating system (OS) (e.g., Linux) and/or a control plane application 522 (e.g., user space or kernel modules) used by SDN controller 542 to configure operation of packet processing pipeline 540. Control plane application 522 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 542 can communicate with ACC 520 using a remote procedure call (RPC) such as Google remote procedure call (gRPC) or other service and ACC 520 can convert the request to target specific protocol buffer (protobuf) request to MCC 530. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 542 can provide packet processing rules for performance by ACC 520. For example, ACC 520 can program table rules (e.g., header field match and corresponding action) applied by packet processing pipeline circuitry 540 based on change in policy and changes in VMs, containers, microservices, applications, or other processes. ACC 520 can be configured to provide network policy as flow cache rules into a table to configure operation of packet processing pipeline 540. For example, the ACC-executed control plane application 522 can configure rule tables applied by packet processing pipeline circuitry 540 with rules to define a traffic destination based on packet type and content. ACC 520 can program table rules (e.g., match-action) into memory accessible to packet processing pipeline circuitry 540 based on change in policy and changes in VMs.

For example, ACC 520 can execute a virtual switch such as Hyper-V virtual switch, Open vSwitch (OVS), Stratum, or Vector Packet Processing (VPP) that provides communications between virtual machines executed by host 500 or with other devices connected to a network. For example, ACC 520 can configure packet processing pipeline circuitry 540 as to which VM is to receive traffic and what kind of traffic a VM can transmit. For example, packet processing pipeline circuitry 540 can execute a virtual switch such as vSwitch or Open vSwitch that provides communications between virtual machines executed by host 500 and packet processing device 510.

MCC 530 can execute a host management control plane, global resource manager, and perform hardware registers configuration. Control plane 532 executed by MCC 530 can perform provisioning and configuration of packet processing circuitry 540. For example, a VM executing on host 500 can utilize packet processing device 510 to receive or transmit packet traffic. MCC 530 can execute boot, power, management, and manageability software (SW) or firmware (FW) code to boot and initialize the packet processing device 510, manage the device power consumption, provide connectivity to Baseboard Management Controller (BMC), and other operations.

One or both control planes of ACC 520 and MCC 530 can define traffic routing table content and network topology applied by packet processing circuitry 540 to select a path of a packet in a network to a next hop or to a destination network-connected device. For example, a VM executing on host 500 can utilize packet processing device 510 to receive or transmit packet traffic.

ACC 520 can execute control plane drivers to communicate with MCC 530. At least to provide a configuration and provisioning interface between control planes 522 and 532, communication interface 525 can provide control-plane-to-control plane communications. Control plane 532 can perform a gatekeeper operation for configuration of shared resources. For example, via communication interface 525, ACC control plane 522 can communicate with control plane 532 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 525 can be utilized by a negotiation protocol and configuration protocol running between ACC control plane 522 and MCC control plane 532. Communication interface 525 can include a general purpose mailbox for different operations performed by packet processing circuitry 540. Examples of operations of packet processing circuitry 540 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 525 can include one or more mailboxes accessible as registers or memory addresses. For communications from control plane 522 to control plane 532, communications can be written to the one or more mailboxes by control plane drivers 524. For communications from control plane 532 to control plane 522, communications can be written to the one or more mailboxes. Communications written to mailboxes can include descriptors which include message opcode, message error, message parameters, and other information. Communications written to mailboxes can include defined format messages that convey data.

Communication interface 525 can provide communications based on writes or reads to particular memory addresses (e.g., dynamic random access memory (DRAM)), registers, other mailbox that is written-to and read-from to pass commands and data. To provide for secure communications between control planes 522 and 532, registers and memory addresses (and memory address translations) for communications can be available only to be written to or read from by control planes 522 and 532 or cloud service provider (CSP) software executing on ACC 520 and device vendor software, embedded software, or firmware executing on MCC 530. Communication interface 525 can support communications between multiple different compute complexes such as from host 500 to MCC 530, host 500 to ACC 520, MCC 530 to ACC 520, baseboard management controller (BMC) to MCC 530, BMC to ACC 520, or BMC to host 500.

Packet processing circuitry 540 can be implemented using one or more of: application specific integrated circuit (ASIC), field programmable gate array (FPGA), processors executing software, or other circuitry. Control plane 522 and/or 532 can configure packet processing pipeline circuitry 540 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 520 or MCC 530. In some examples, a P4 program can be compiled and provided to MCC 530 to configure packet processing circuitry 540. The following is a JSON configuration file that can be transmitted from ACC 520 to MCC 530 to get capabilities of packet processing circuitry 540 and/or other circuitry in packet processing device 510. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 5B depicts an example network interface device or packet processing device. In some examples, circuitry of network interface device can be utilized by network interface 510 (FIG. 5A) or another network interface for packet transmissions and packet receipts, as described herein. In some examples, network interface device 550 can be implemented as a network interface controller, network interface card, a host fabric interface (HFI), or host bus adapter (HBA), and such examples can be interchangeable. Packet processing device 550 can be coupled to one or more servers using a bus, PCIe, CXL, or Double Data Rate (DDR). Packet processing device 550 may be embodied as part of a system-on-a-chip (SoC) that includes one or more processors, or included on a multichip package that also contains one or more processors.

Some examples of network interface device 550 are part of an Infrastructure Processing Unit (IPU) or data processing unit (DPU) or utilized by an IPU or DPU. An xPU or XPU can refer at least to a network interface device, GPU, general purpose GPU (GPGPU), or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 550 can include transceiver 552, transmit queue 556, receive queue 558, memory 560, host interface 562, DMA engine 564, and processors 580. Transceiver 552 can be capable of receiving and transmitting packets in conformance with the applicable protocols such as Ethernet as described in IEEE 802.3, although other protocols may be used. Transceiver 552 can receive and transmit packets from and to a network via a network medium (not depicted). Transceiver 552 can include PHY circuitry 554 and media access control (MAC) circuitry 555. PHY circuitry 554 can include encoding and decoding circuitry (not shown) to encode and decode data packets according to applicable physical layer specifications or standards. MAC circuitry 555 can be configured to assemble data to be transmitted into packets, that include destination and source addresses along with network control information and error detection hash values.

Processors 580 can be any a combination of a: processor, core, graphics processing unit (GPU), field programmable gate array (FPGA), application specific integrated circuit (ASIC), or other programmable hardware device that allow programming of network interface 550. For example, a “smart network interface” can provide packet processing capabilities in the network interface using processors 580.

Processors 580 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 580, including its data plane, can be programmed based on one or more of: a configuration file, OneAPI, Programming protocol independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries, or others.

As described herein, processors 580 or other circuitry can be configured by communications received from a bus driver via one or more child device drivers (e.g., IDPF drivers) or other interfaces.

Packet allocator 574 can provide distribution of received packets for processing by multiple CPUs or cores using timeslot allocation described herein or RSS. When packet allocator 574 uses RSS, packet allocator 574 can calculate a hash or make another determination based on contents of a received packet to determine which CPU or core is to process a packet.

Interrupt coalesce 572 can perform interrupt moderation whereby network interface interrupt coalesce 572 waits for multiple packets to arrive, or for a time-out to expire, before generating an interrupt to host system to process received packet(s). Receive Segment Coalescing (RSC) can be performed by network interface 550 whereby portions of incoming packets are combined into segments of a packet. Network interface 550 provides this coalesced packet to an application.

Direct memory access (DMA) engine 564 can copy a packet header, packet payload, and/or descriptor directly from host memory to the network interface or vice versa, instead of copying the packet to an intermediate buffer at the host and then using another copy operation from the intermediate buffer to the destination buffer.

Memory 560 can be any type of volatile or non-volatile memory device and can store any queue or instructions used to program network interface 550. Transmit queue 556 can include data or references to data for transmission by network interface. Receive queue 558 can include data or references to data that was received by network interface from a network. Descriptor queues 570 can include descriptors that reference data or packets in transmit queue 556 or receive queue 558. Host interface 562 can provide an interface with host device (not depicted). For example, host interface 562 can be compatible with PCI Express, PCI-x, Serial ATA, and/or USB compatible interface (although other interconnection standards may be used).

FIG. 6 depicts a system. In some examples, circuitry of network interface device or other device can be configured by communications received from a bus driver via one or more child device drivers (e.g., IDPF drivers) or other interfaces, as described herein. System 600 includes processor 610, which provides processing, operation management, and execution of instructions for system 600. Processor 610 can include any type of microprocessor, central processing unit (CPU), graphics processing unit (GPU), xPU, processing core, or other processing hardware to provide processing for system 600, or a combination of processors. An xPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a display that provides an output to a user. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 632, a system administrator, and/or orchestrator can configure network interface 650 by communications received from a bus driver via one or more child device drivers (e.g., IDPF drivers) or other interfaces.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIG. 5A or 5B.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. A non-volatile memory (NVM) device is a memory whose state is determinate even if power is interrupted to the device.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), RoCEv2, Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

1. At least one non-transitory computer-readable medium, comprising instructions stored thereon, that if executed by one or more processors, cause the one or more processors to:
execute a bus driver to provide an operating system (OS) with access to multiple interfaces to a network interface device, wherein the multiple interfaces to the network interface comprise two or more of: queues and contexts associated with different networking, memory, or storage protocols; access to multiple virtual networks; a device activity log; a Network Driver Interface Specification (NDIS) consistent interface; an interface to a firmware log; a device management interface; a diagnostics interface; an interface to configure the network interface device; access to operations offloaded to the network interface device; configuration of pacing of packet transmission; or access to pooled memory.

2. The computer-readable medium of claim 1, wherein the bus driver is to express multiple ports of a single Peripheral Component Interconnect Express (PCIe)-accessible device to an NDIS driver.

3. The computer-readable medium of claim 2, wherein the NDIS driver is to communicate with multiple virtual channels via the bus driver.

4. The computer-readable medium of claim 3, wherein the multiple virtual channels are associated with independent queues and context for packet transmission and receipt.

5. The computer-readable medium of claim 2, wherein the bus driver is to communicate with a number of physical device objects (PDOs) corresponding to the number of ports and wherein IDPF drivers provide interfaces between the PDOs and the NDIS or the OS.

6. The computer-readable medium of claim 1, wherein the bus driver is to allocate a physical device object (PDO) for one of the multiple interfaces in accordance at least with Intel Scalable I/O Virtualization (S-IOV) or Single Root I/O Virtualization (SR-IOV) over Peripheral Component Interconnect Express (PCIe) or Compute Express Link (CXL).

7. The computer-readable medium of claim 1, wherein the bus driver is to allocate a virtual function (VF) for one of the multiple interfaces in accordance at least with Intel Scalable I/O Virtualization (S-IOV) or Single Root I/O Virtualization (SR-MY) over Peripheral Component Interconnect Express (PCIe) or Compute Express Link (CXL).

8. A method comprising:
utilizing a bus driver to present a peripheral device comprising a single physical function to a host operating system (OS) as a plurality of presented peripheral devices;
associating the plurality of presented peripheral devices with a corresponding plurality of physical Ethernet ports; and
enabling the host OS to interact with the plurality of peripheral devices, wherein a number of the plurality of peripheral devices correlates to the number of physical Ethernet ports associated with the peripheral device.

9. The method of claim 8, further comprising a Bus Driver associated with the single physical function (PF) of the peripheral device.

10. The method of claim 8, wherein the bus driver performs device initialization and resource management for the peripheral device and wherein the bus driver presents the plurality of peripheral devices to the host OS using standard OS interface (NDIS).

11. The method of claim 8, wherein a number of peripheral devices expressed in the plurality of peripheral devices is equal to, or a positive integer multiple of, the number of physical Ethernet ports associated with the peripheral device.

12. The method of claim 8, wherein the host OS comprises a network interface, a storage interface, and/or a memory pooling interface and further comprising loading a secondary driver on the plurality of peripheral devices presented by the bus driver to enable interaction with the host OS network interface, storage interface, and/or memory pooling interface.

13. The method of claim 12, wherein the secondary driver comprises a Network Driver Interface Specification (NDIS) consistent interface.

14. The method of claim 8, wherein the peripheral device further comprises a host interface; the host interface comprising a PCI Express (PCIe) interface, a Compute Express Link (CXL) interface, a Universal Chiplet Interconnect Express (UCIe) interface, an Intel On-Chip System Fabric (IOSF) interface, or an NVLink interface.

15. The method of claim 8, wherein the peripheral device further comprises a SmartNIC, an infrastructure processing unit (IPU), an edge processing unit (EPU), a data processing unit (DPU), or an X processing unit (xPU).

16. An apparatus comprising:
a network interface device comprising:
a device interface;
a network interface
a direct memory access (DMA) circuitry; and
circuitry to:
provide access to circuitry of the network interface device to a network device driver via a processor-executed bus driver that provides access to multiple virtual devices of the network interface device.

17. The apparatus of claim 16, wherein the network device driver comprises a Network Driver Interface Specification (NDIS) driver.

18. The apparatus of claim 16, wherein the multiple virtual devices of the network interface device comprise independent networking contexts for different ports of the network interface device.

19. The apparatus of claim 16, wherein the circuitry is to provide access to data and capabilities of the network interface device via multiple interfaces to the bus driver, wherein the data and capabilities of the network interface device comprise two or more of: queues and contexts associated with different networking, memory, or storage protocols; a device activity log; a firmware log; a diagnostics log; configuration of pacing of packet transmission; or access to pooled memory.

20. The apparatus of claim 16, wherein the bus driver is to allocate a virtual function (VF) for one of the multiple interfaces in accordance at least with Intel Scalable I/O Virtualization (SIOV) or Single Root I/O Virtualization (SR-MY) over Peripheral Component Interconnect Express (PCIe) or Compute Express Link (CXL).
